(19) United States
(12) Patent Application Publication
(10) Pub. No.: US 2014/0098104 A1
(43) Pub. Date: Apr. 10, 2014

(54) TECHNIQUES TO PRESENT EVENT INFORMATION USING AN EVENT TIMING VISUALIZATION

(71) Applicant: MICROSOFT CORPORATION, Redmond, WA (US)

(72) Inventors: Mai Kirknel, Hellerup (DK); Mirza Abdic, Jyllinge (DK); Doina Babu, Copenhagen (DK); Andrés del Campo Novales, Holte (DK)

(73) Assignee: MICROSOFT CORPORATION, Redmond, WA (US)

(21) Appl. No.: 13/648,548

(22) Filed: Oct. 10, 2012

(51) Int. Cl. G06T 11/20; G06T 1/00

(52) U.S. Cl. 345/440.2; 345/501

(57) ABSTRACT

Techniques to present event information as event timing visualizations are described. An apparatus may comprise an event visualization application comprising an event information component operative to determine a set of events and associated time periods, and an event presentation component operative to generate an event timing visualization to present multiple graphical user interface (GUI) elements representing the set of events and associated time periods relative to a current time period, the event timing visualization comprising a first dimension representing a count of events and a second dimension representing a time period for events, wherein a position of the current time period is between a set of endpoints for the second dimension. Other embodiments are described and claimed.

### BACKGROUND

Many entities, such as businesses, have supply relationships with other entities managed by some form of an electronic system. That is, many entities operate, at least in part, by buying and selling products and services from and to other entities. Some entities manage supply relationships based on temporal information, such as when products or services are to be ordered, shipped and delivered. Managing such temporal information is a challenge, given that documents (e.g., a purchase order) and associated temporal information (e.g., a delivery date) may be stored as a single integrated data item that needs some form of extraction, as different data items in a same or different electronic system, or some combination of both. This problem is exacerbated given the large volumes of products, services, entities, documents, and other business information stored by an electronic system. As such, it may be difficult for a user to quickly determine status for certain items based on temporal information. For instance, a user may need to look up separate data items within a system to determine whether it is overdue, or run reports for lists of overdue items and sift through the lists for relevant information. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to visually manage, present, navigate, and interact with a visualization having a combination of event and temporal information. Some embodiments are particularly directed to techniques to present event and temporal information using an innovative event timing visualization.

In one embodiment, for example, an apparatus may comprise an event visualization application operative on a logic device, such as a processor circuit. The event visualization application may comprise an event information component operative to determine a set of events and associated time periods. The event visualization application may further comprise an event presentation component operative to generate an event timing visualization to present multiple graphical user interface (GUI) elements representing the set of events and associated time periods relative to a current time period. The event timing visualization may comprise a first dimension representing a count of events and a second dimension representing a time period for events, wherein a position of the current time period is between a set of endpoints for the second dimension. In this manner, events that are overdue relative to the current time period may be quickly ascertained in a visual manner. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of an event visualization system.

FIG. 2A illustrates an embodiment of a database for event information.

FIG. 2B illustrates an embodiment of an event timeline.

FIG. 3 illustrates an embodiment of an event timing visualization.

FIG. 4 illustrates an embodiment of an implementation for an event timing visualization.

FIG. 5 illustrates an embodiment of selecting a first GUI element of an event timing visualization.

FIG. 6 illustrates an embodiment of manipulating a first GUI element of an event timing visualization.

FIG. 7 illustrates an embodiment of selecting a second GUI element of an event timing visualization.

FIG. 8 illustrates an embodiment of manipulating a second GUI element of an event timing visualization.

FIG. 9 illustrates an embodiment of modifying a database of event information.

FIG. 10A illustrates an embodiment of a first logic flow.

FIG. 10B illustrates an embodiment of a second logic flow.

FIG. 11A illustrates an embodiment of a centralized system.

FIG. 11B illustrates an embodiment of an implementation of a centralized system.

FIG. 12 illustrates an embodiment of a distributed system.

FIG. 13 illustrates an embodiment of a computing architecture.

FIG. 14 illustrates an embodiment of a communications architecture.

### DETAILED DESCRIPTION

Various embodiments are generally directed to techniques for improving graphical representation of data. Some embodiments are particularly directed to techniques for generating a custom visual graphical representation suitable for presenting, navigating, and managing larger volumes of information, particularly event and temporal based information, referred to herein as an event timing visualization. As a result, a user can analyze large quantities of business information in a more efficient and effective manner.

In one embodiment, techniques may be used to generate an event timing visualization. An event timing visualization may comprise a visual graphical representation of event and temporal information. More particularly, an event timing visualization may comprise multiple graphical user interface (GUI) elements representing a set of events and associated time periods relative to a current time period. The event timing visualization may further comprise a first dimension representing a count of events and a second dimension representing a time period for events, wherein a position of the current time period is between a set of endpoints for the second dimension. In one embodiment, for example, an event timing visualization may comprise a bar graph or bar chart implemented as a Cartesian coordinate system, with a y-axis representing a count of events (e.g., documents) and an x-axis representing a time period for events (e.g., due dates for documents). The x-axis may include a current date (e.g., today), with time periods before and after the current date within a given time frame (e.g., 30 days). The bar graph may present GUI elements in the form of bars or blocks representing events positioned at associated time periods along the x-axis. In this manner, a user may quickly ascertain those events that are past due the current date, and also by how many days past the current date, in a compact and single user interface view. Furthermore, associated time periods may be modified directly from selectable GUI elements of the event timing visualization. For instance, movement of a GUI element representing an event to a different time period will automatically update underlying temporal information for the event stored in a database. As a result, a user can ascertain large volumes of business information with temporal components in a visual manner, and make business decisions accordingly.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the custom purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the method steps. The structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

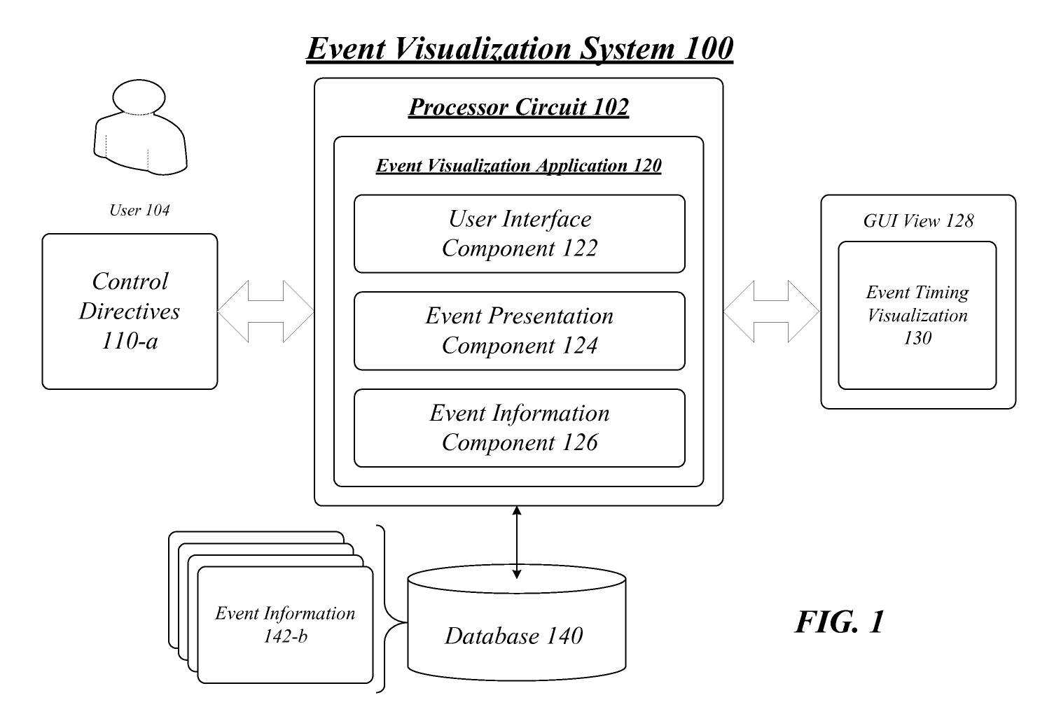

FIG. 1 illustrates a block diagram for an event visualization system 100. The event visualization system 100 may be generally arranged to manage different types of information, including business information having some form of defined relationships or order. The event visualization system 100 may be particularly arranged to handle large volumes of business information having a temporal component in a manner that is not found in traditional graphical visualization and analysis, such as through charts, graphs or tables. In one embodiment, for example, the event visualization system 100 may be implemented as decision support system (DSS) designed to handle massive amounts of centralized or distributed information for a given business, enterprise or organization across multiple entities, products, services and geographies. A DSS may comprise a computer-based information system that supports decision-making activities for a business or organization. An example of a DSS may include without limitation an enterprise resource planning (ERP), among other business support systems. The embodiments are not limited in this context.

The event visualization system 100 may have one or more software applications and/or software components. In the illustrated embodiment shown in FIG. 1, the event visualization system 100 comprises an event visualization application 120. The event visualization application 120 comprises a user interface component 122, an event presentation component 124, and an event information component 126. Although the event visualization system 100 shown in FIG. 1 has a limited number of elements in a certain topology, it may be appreciated that the event visualization system 100 may include more or less elements in alternate topologies as desired for a given implementation. The embodiments are not limited in this context.

The event visualization application 120 may generally comprise an application program specifically designed to present graphical representations for event information 142-b in response to one or more control directives 110-a. In various implementations, the event visualization application 120 may provide a graphical user interface (GUI), either natively or via the user interface component 122, to communicate information between the event visualization application 120 and an output device (e.g., an electronic display) suitable for presenting information to a user 104. The event visualization application 120 may comprise a stand-alone application program, or may be an integrated part of another application program. An application program is any software program that generally allows a user to accomplish one or more specific tasks. Examples of application programs may include without limitation information technology (IT) management applications, human resource management applications, enterprise resource planning (ERP) applications, customer resource management (CRM) applications, financial management applications, business intelligence applications, customer relationship management applications, report generating applications, statistical analysis applications, business planning applications, project management applications, productivity applications, word processing applications, spreadsheet applications, database applications, and so forth. In one embodiment, for example, the event visualization application 120 may be implemented as part of one or more ERP applications, including without limitation MICROSOFT DYNAMICS AX ® from MICROSOFT® CORPORATION, SAP BUSINESS SUITE® from SAP®, and ORACLE E-BUSINESS SUITE® from ORACLE®, among others. The embodiments, however, are not limited to these examples.

It is worthy to note that “a” and “b” and “c” and similar designators as used herein are intended to be variables representing any positive integer. Thus, for example, if an implementation sets a value for a=5, then a complete set of control directives 110-a may include control directives 110-1, 110-2, 110-3, 110-4 and 110-5. The embodiments are not limited in this context.

In one embodiment, the event visualization application 120 may comprise a user interface component 122. The user interface component 122 may generate various GUI views, such as the GUI view 128. In one embodiment, the user interface component 122 may comprise part of the event visualization application 120. In one embodiment, the user interface component 122 may comprise part of another software application, such as an operating system (OS) for the event visualization application 120.

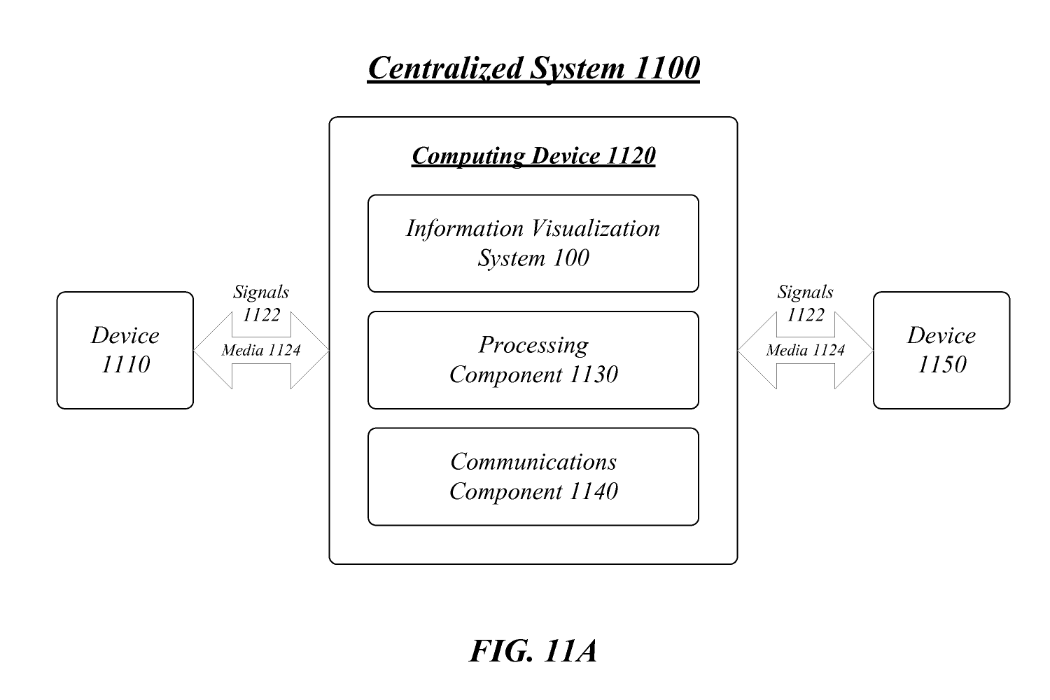

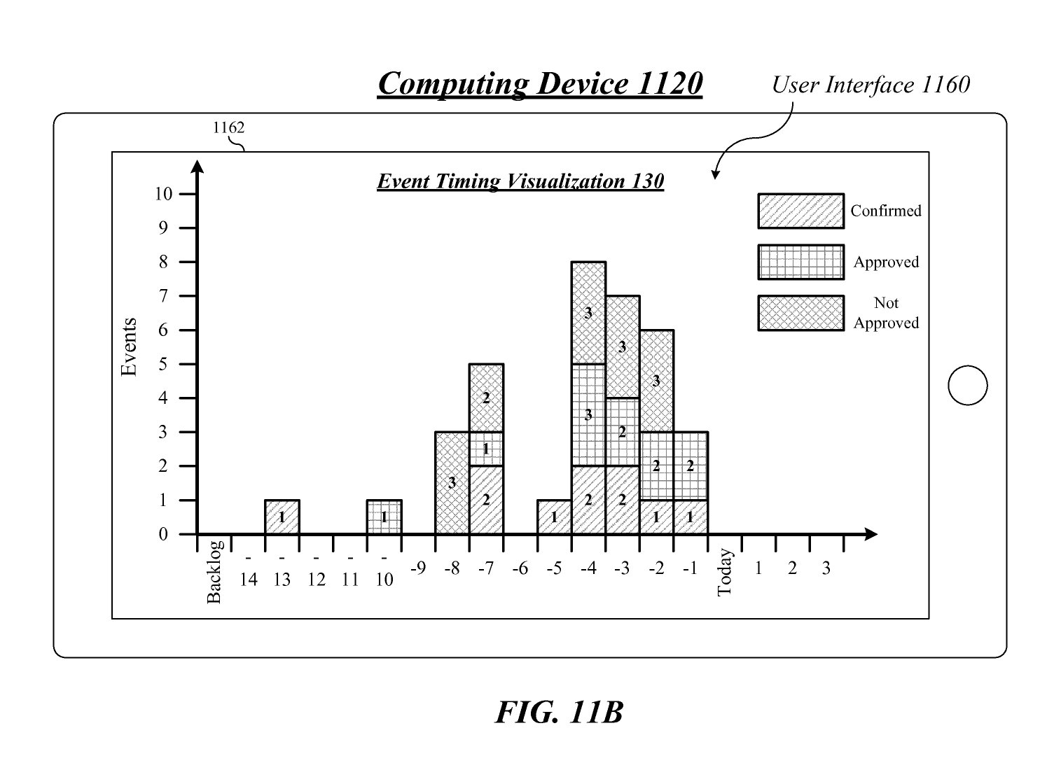

The event visualization application 120 may comprise an event presentation component 124. The event presentation component 124 may be arranged to generate an event timing visualization 130 to present event information 142-b, including temporal information, in a single graphical user interface (GUI) view 128. A user 104 may manipulate the event timing visualization 130 via one or more human input devices arranged to generate and send control directives 110-a as input to the event presentation component 124 in response to user commands from the user 104. The user commands may be received in numerous ways, including clicks, pointers, gestures, voice commands, and so forth. Exemplary devices are described with reference to FIGS. 11-14.

The event visualization application 120 may also comprise an event information component 126. The event information component 126 may generally manage various sets of event information 142-b stored by the database 140. For instance, the event information component 126 may process event information 142-b in order to prepare the event information 142-b for use by the event presentation component 124. For example, the event information component 126 may be operative to retrieve event information 142-b stored in a database 140, or receive event information 142-b from a remote data source.

The event information 142-b may represent business events and supporting documentation, such as application files, documents, purchase orders, contracts, agreements, electronic messages, internal communications, external communications, decision points, screen shots, and other documentation. Examples of electronic messages may include without limitation voicemail messages, email messages, text messages, short messaging service (SMS) messages, multimedia messaging service (MMS) messages, chat messages, social networking system (SNS) messages, and so forth. In some cases, the event information component 126 may perform pre-processing operations to prepare the event information 142-b for use by the event presentation component 124. For instance, the event information component 126 may receive the event information 142-b, such as from a local datastore (e.g., database 140) or a remote datastore, and parse the event information 142-b into a data structure having a data schema suitable for use by the event visualization application 120. To the extent that the event information 142-b and the event visualization application 120 use different data schemas, one or more custom translation components (not shown) may be used to translate the event information 142-b from a native data schema to one used by the event visualization application 120.

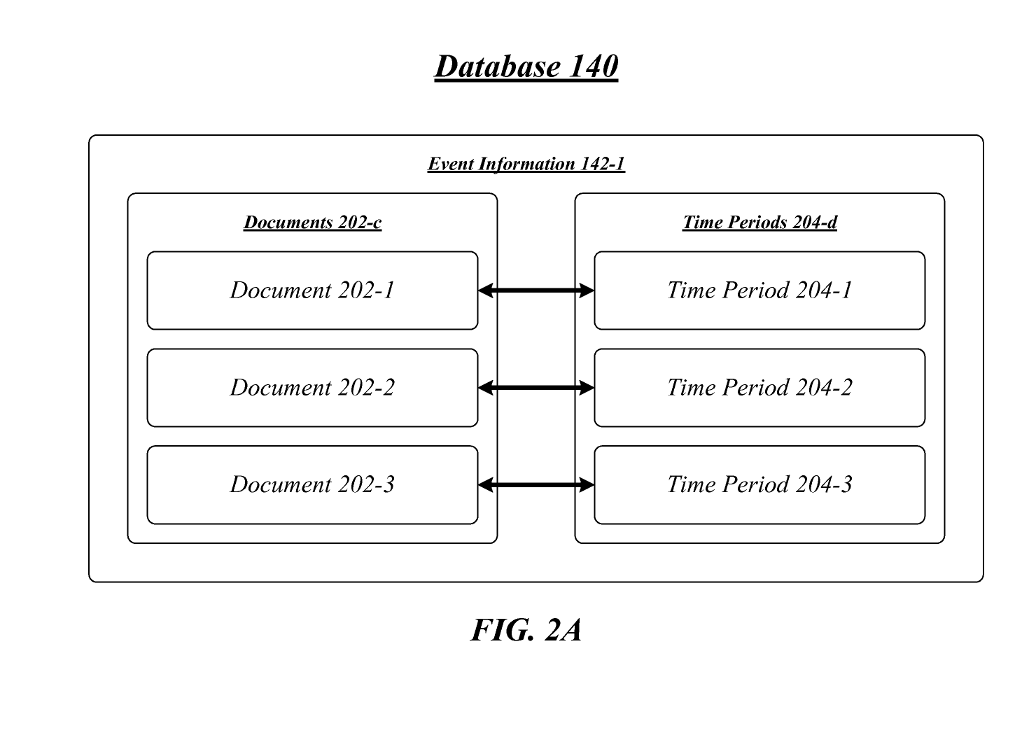

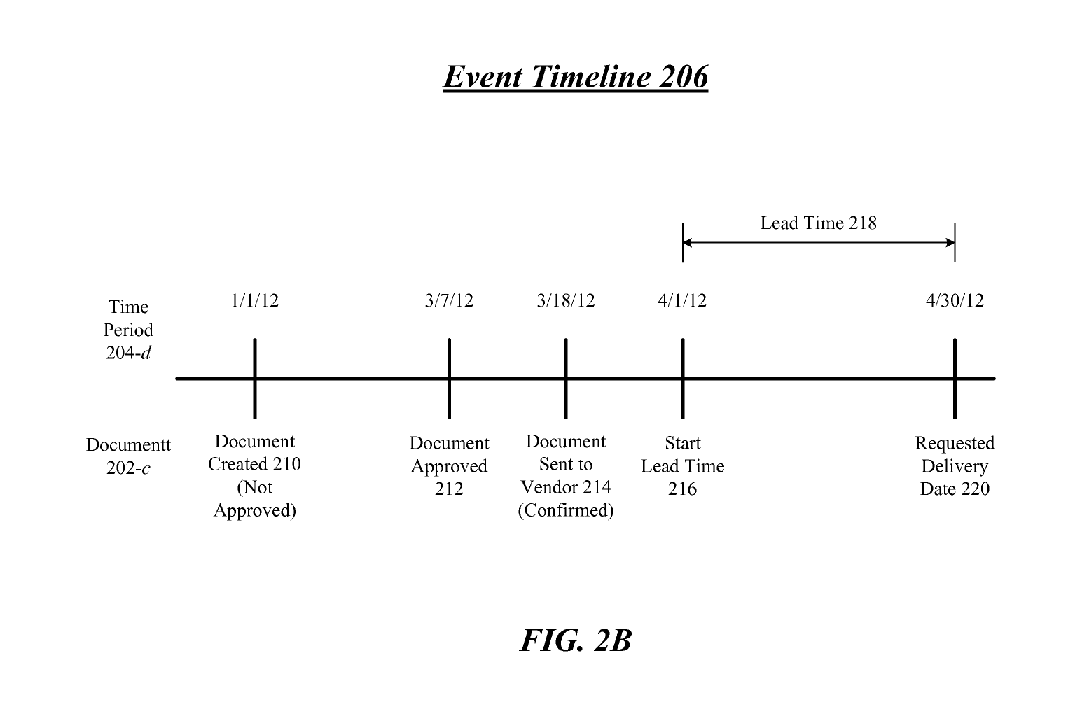

FIG. 2A illustrates an exemplary implementation for event information 142-b stored by the database 140 before any visualization operations have been performed. By way of example and not limitation, FIG. 2A illustrates a set of exemplary event information 142-1. The event information 142-1 may comprise a set of documents 202-c and associated time periods 204-d. In this example, the documents 202-c may represent a type of event and the associated time periods 204-d may represent times and/or dates associated with each document 202-c. For instance, a document 202-1 may comprise a purchase order and an associated time period 204-1 may comprise a delivery date for goods. Although FIG. 2A illustrates a one-to-one correspondence between documents 202-c and associated time periods 204-d for purposes of clarity, it may be appreciated that a single document 202-c may be associated with multiple time periods 204-d in a one-to-many relationship, multiple documents 202-c may be associated with a single time period 204-d in a many-to-one relationship, and multiple documents 202-c may be associated with multiple time periods 204-d in a many-to-many relationship. The embodiments are not limited in this context.

FIG. 2B illustrates an exemplary event timeline 206 for the event information 142-1 as described with reference to FIG. 2A. The event timeline 206 may illustrate typical examples of various type of documents 202-c and associated time periods 204-d as stored in database 140. As shown in FIG. 2B, the event timeline 206 may include multiple documents 202-c, such as a document created event 210, a document approved event 212, a document sent to vendor event 214, a start lead time event 216, a lead time event 218, and a requested delivery date event 220. The event timeline 206 may include multiple time periods 204-d associated with each of the documents 202-c, such as a date Jan. 1, 2012 associated with the document created event 210, a date Mar. 7, 2012 associated with the document approved event 212, a date Mar. 18, 2012 associated with the document sent to vendor event 214, a date Apr. 1, 2012 associated with the start lead time event 216, a time period of 30 days (inclusive) between a set of dates Apr. 1, 2012 and Apr. 30, 2012 associated with the lead time event 218, and a date Apr. 30, 2012 associated with the requested delivery date event 220. Although days are shown as time period 204-d, it may be appreciated that any time granularity (e.g., seconds, minutes, days, weeks, bi-weeks, months, quarters, years, decades, etc.) may be used as desired for a given implementation. The embodiments are not limited in this context.

The event timeline 206 helps to illustrate a problem associated with conventional electronic systems, such as conventional ERP systems. In order for a user 104 to determine whether an order is overdue, the user 104 may need to inspect some or all of the documents 202-c and determine whether associated time periods 204-d have been missed by a vendor. Conventional attempts at coalescing and aggregating relevant data may be limited to reports and lists, such as an aging report. However, given the volume of data stored by an ERP system, such reports and lists may be voluminous and may take a significant amount of time to traverse by the user 104. Charts, graphs and other visual aids may be used in an attempt to visually represent such data. However, these visual aids do not allow the user 104 an opportunity to instantly visualize which items are overdue, and potentially overdue, relative to a current time period in a compact and single user interface view. Embodiments attempt to solve these and other problems.

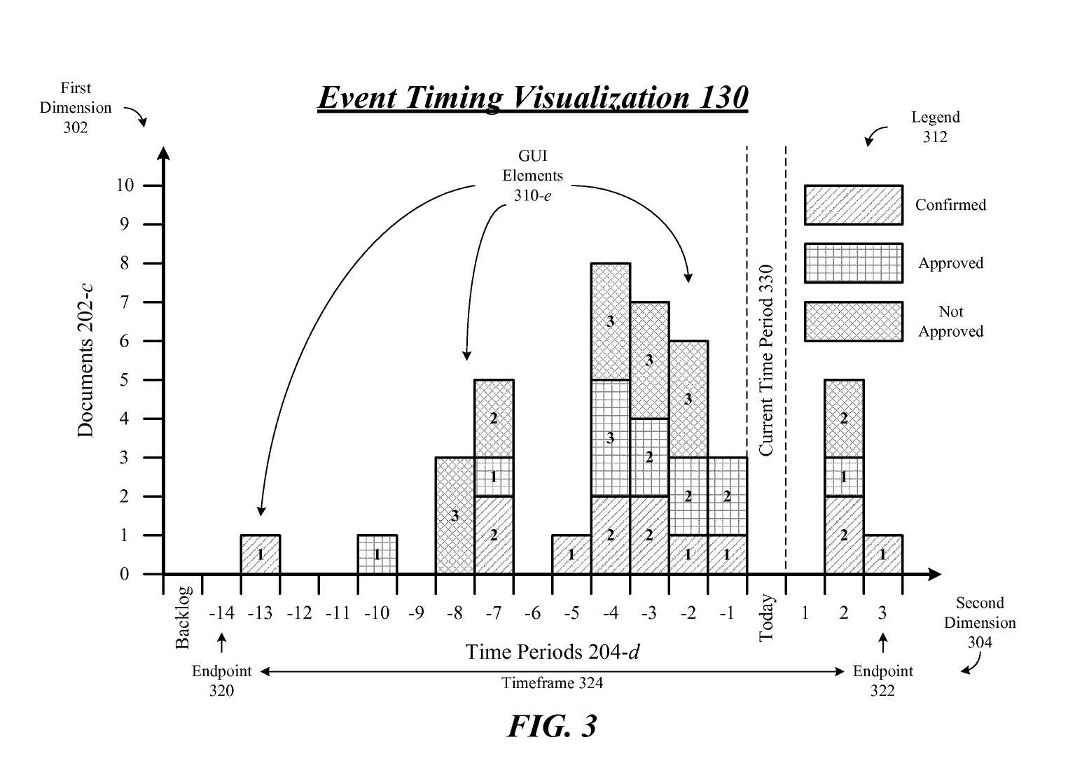

FIG. 3 illustrates an exemplary implementation of an event timing visualization 130 implemented as a bar chart or bar graph (collectively referred to herein as a “bar graph”). Although an exemplary event timing visualization 130 is shown as a bar graph, it may be appreciated that other graphical representations of data (e.g., histogram, pie chart, line chart, etc.) may be modified and used consistent with the embodiments described herein. The embodiments are not limited in this context.

In general, a bar graph is a graphical representation of data with rectangular bars with lengths proportional to the values that they represent. The bars can be plotted vertically or horizontally. Bar graphs provide a visual presentation of categorical data. Categorical data is a grouping of data into discrete groups, such as documents 202-c and time periods 204-d. In a column bar chart, categories appear along a horizontal axis (x-axis), while a height of a bar corresponds to the value of each category along a vertical axis (y-axis). As shown in FIG. 3, the event timing visualization 130 may be implemented as a stacked bar graph. A stacked bar graph stacks bars that represent different groups on top of each other. A height of a resulting bar shows the combined result of the groups.

The event presentation component 124 may generate an event timing visualization 130 to present multiple graphical user interface (GUI) elements 310-e representing a set of documents 202-c and associated time periods 204-d relative to a current time period 330 having a daily level of granularity. In the example shown in FIG. 3, the current time period 330 is labeled “Today.” The event timing visualization 130 may comprise a first dimension 302 representing a count of documents 202-c and a second dimension 304 representing a time period 204-d for documents 202-c. A position for the current time period 330 labeled “Today” may occur between a set of endpoints 320, 322 for the second dimension 304 along a timeframe 324, which in this case is defined between—14 days to 3 days for a total of 17 days.

The GUI elements 310-e of the event timing visualization 130 may comprise different visual graphical representations of an object. The GUI elements 310-e may have different visual properties, such as colors, shapes, sizes or geometries, depending on what type of information the GUI elements 310-e are representing. For instance, different categories of events 202-c may have different colors or patterns. As shown in FIG. 3, the GUI elements 310-e may comprise bars or blocks representing various categories of events 202-c as defined by a legend 312. The categories may include confirmed, approved and not approved. It may be appreciated, however, that different shapes, colors, graphical effects, and other visual indicia may be used as well. The embodiments are not limited in this context.

In this example, the categories may include confirmed, approved and not approved. The categories of events may represent a document that is in an approved state and that are expected to get confirmed by a vendor before goods need to be shipped in order for on time delivery. This may comprise an expected event that appears in the event timing visualization 130 in the time period where it should have at latest happened. For instance, if the system knows that the goods has to be shipped in 2 days to meet a requested delivery date, then the event of getting a commitment from the vendor on the date should happen at latest on the date where it should be shipped. So the event of getting a commitment from the vendor is what is shown in the event timing visualization 130. This would fall in the time period of “2.” Depending on a state of a document (e.g., a category of event), this might be more critical. For instance, if a document is not even internally approved yet then it becomes even more critical as it might need to go through an internal review process first.

The flexible use of categories of events for an event timing visualization 130 may be useful in a variety of ways. For instance, in many cases it is necessary to react on exceptions, events that should have happened but did not happen at the latest expected date or time. It is also a substantial advantage to be prepared for potential exceptions, meaning events approaching their latest due date but have not yet happened. For instance, assume purchase departments are sending out purchase orders to their vendors and receiving confirmation on the dates where the vendor can deliver the goods. They need a confirmation from the vendor within a certain time before the goods actually have to be delivered. So there is a latest expected date that the order needs to be confirmed.

As shown in FIG. 3, the event timing visualization 130 may provide a visualization of upcoming events that need to happen relative to the current time period 330. The event timing visualization 130 may also provide a visualization of events that have not happened as expected, and thereby are considered “overdue” in the timeframe 324 relative to the current time period 330. The event timing visualization 130 can show time dependent events coming up, due or past due. In this example, the expected events are only shown in the event timing visualization 130 if they have not happened. This will allow the user to react on exceptions, that is, events that did not happen in time and events that are expected to happen in the nearest days but have not happened yet.

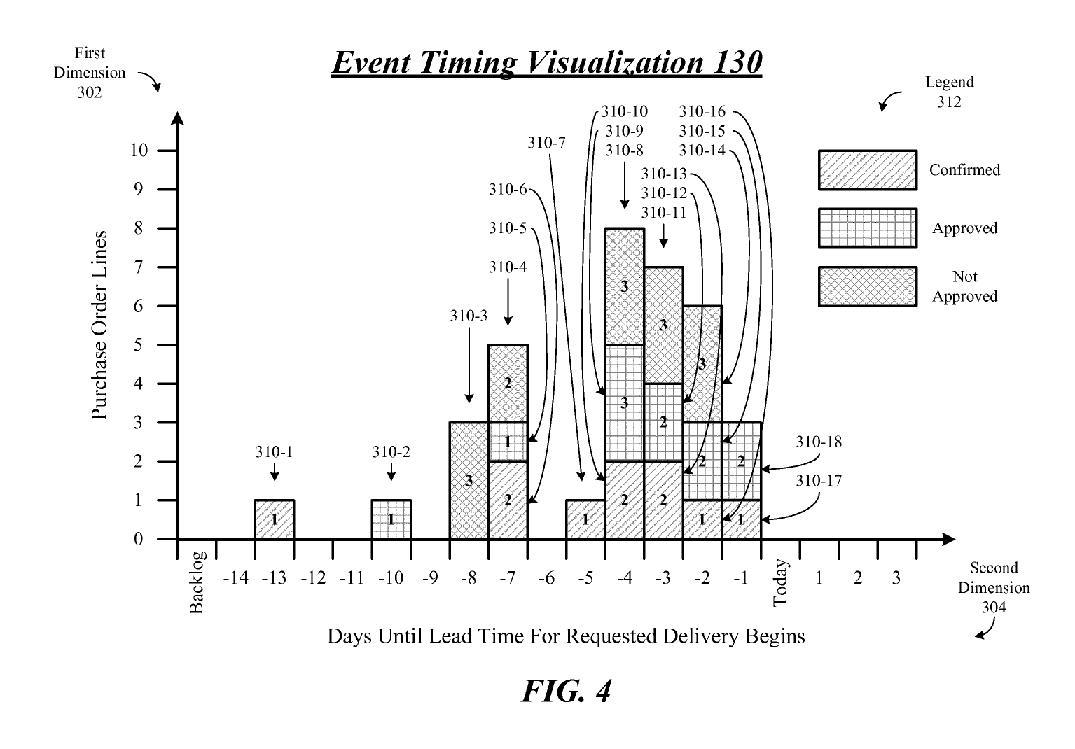

FIG. 4 illustrates an exemplary implementation for the event timing visualization 130 with further description for the GUI elements 310-e. As shown in FIG. 4, the y-axis is a count of expected events, or documents 202-c, on which the expected event is recorded. For instance, these could be purchase orders that need confirmation from vendor at the latest on a certain day, or it could be production orders that are expected to be finished at a certain day. If the purchase order gets confirmed by the vendor then it will not appear in the event timing visualization 130. Once the production order is finished then it is removed from the count.

The x-axis represents a time relative to today. Continuing with the previous example of purchase orders, the x-axis may represent a number of days until lead time for requested delivery begins. When a count of expected events are placed left of the current time period 330 (e.g., today), under a negative number . . . −5,−4,−3,−2,−1, then the expected event has not happened in time. Rather, it has been delayed with respectively 5, 4, 3, 2, 1 day(s). When count of expected events is placed at the current time period 330 (e.g., today) then the event should happen today. If a count of expected events is placed to the right of today under a positive number 1, 2, 3, 4, 5 . . . , then the event is expected to happen in respectively 1, 2, 3, 4, 5 etc. days. The count in the y-axis can come from multiple sources which are represented as stacked bars.

As previously described, an event may comprise a document 202-c in multiple states. For the event timing visualization 130 shown in FIG. 3, there are 3 categories or states shown in the legend 312 as confirmed, approved and not approved. Counts of documents 202-c matching a particular state are represented by a GUI element 310-e, which in this case is a block having a shading matching its current state. For instance, a GUI element 310-1 may represent a document 202-1 that has been “confirmed” and is 13 days overdue. When there are multiple documents 202-c of the same category on a same day, the number of multiple documents 202-c may be presented by a value within the appropriate GUI element 310-e and/or a height for the GUI element 310-e. For instance, a GUI element 310-4 may represent two documents 202-2, 202-3 of the same category of “not approved” that are 7 days overdue, which is represented by a value of “2” positioned within the GUI element 310-4. Further, the GUI element 310-4 itself has a height along the y-axis representing a count of 2, which in this case is positioned between 3 and 5 on the y-axis.

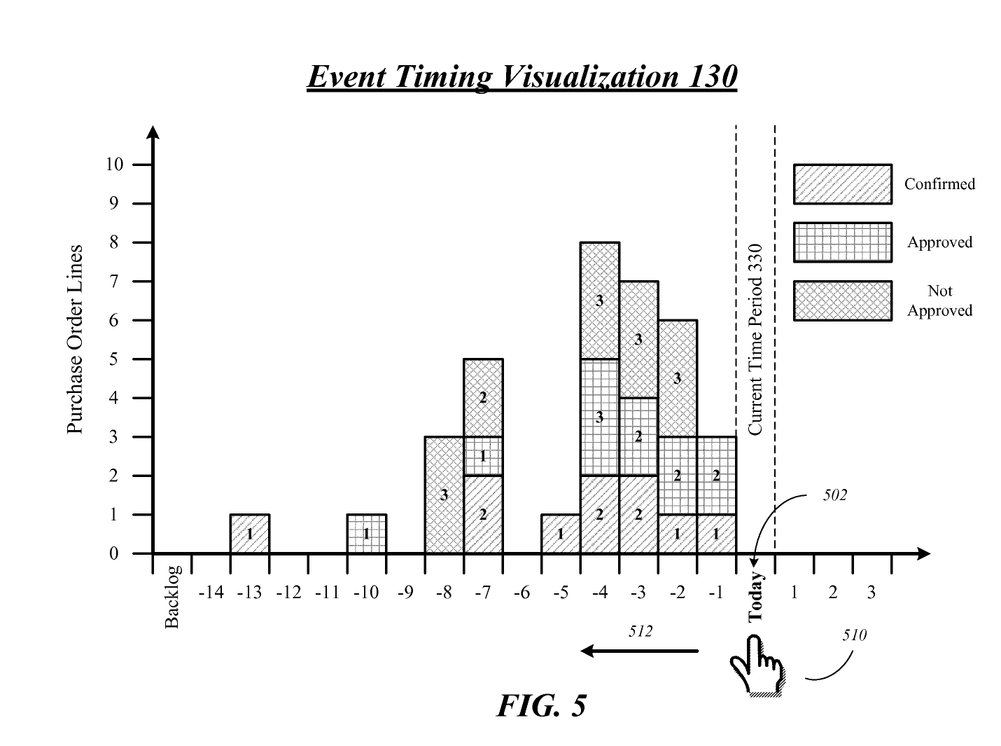

FIG. 5 illustrates an exemplary implementation for the event timing visualization 130 with further description of one or more selectable GUI elements 502 prior to activation. The timeframe 324 shown in FIG. 3 can be configured to look further ahead in time (e.g., expand to the right of today) or look further back in time (e.g., expand to the left of today) relative to the current time period 330 of “today.” For instance, the user 104 may utilize a human interface device, such as a touch screen for a mobile device, to select a selectable GUI element 502 via a human object 510 (e.g., a human finger), and drag the selected GUI element 502 from right to left as indicated by direction 512. The user interface component 122 may receive one or more control directives 110-a indicative of selection of the selectable GUI element 502 of the event timing visualization 130 representing the current time period 330 to move the position of the current time period 330 between the set of endpoints 320, 322 for the second dimension 304 (e.g., the x-axis). The event presentation component 124 may then modify the event timing visualization 130 in accordance with the control directives.

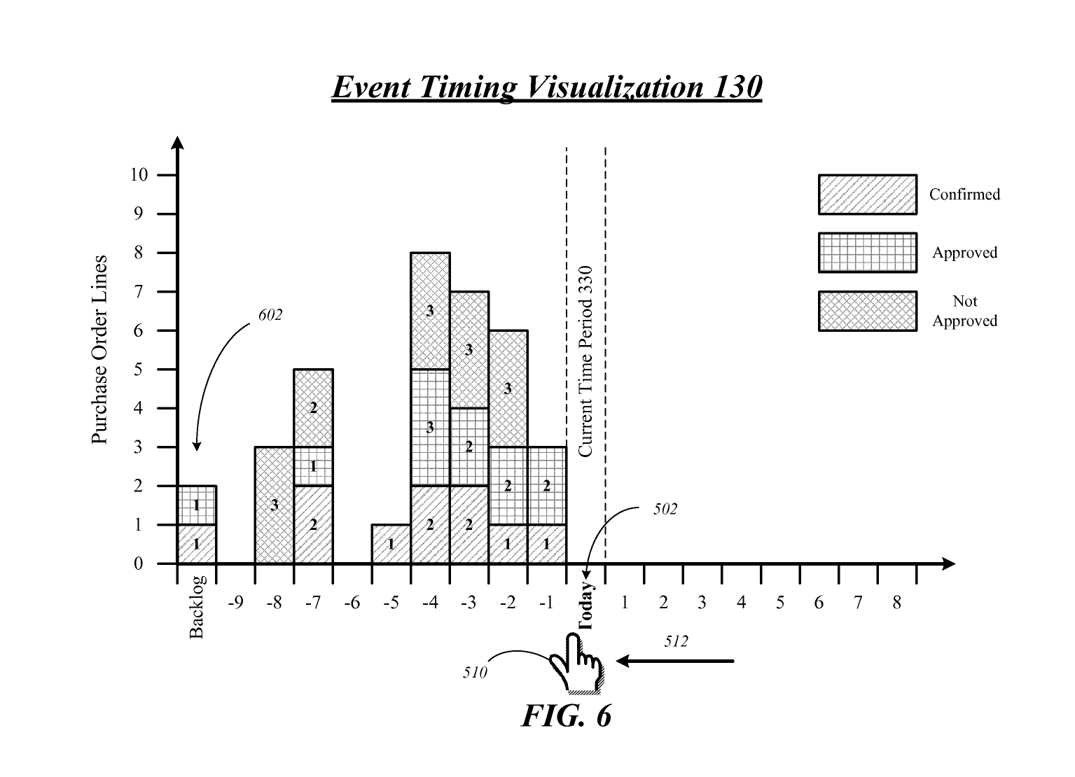

FIG. 6 illustrates an exemplary implementation for the event timing visualization 130 with further description of one or more selectable GUI elements 502 after activation. Once the user interface component 122 receives and processes the control directives 110-a, the event presentation component 124 may move the position of the current time period 330 within the second dimension 304 in response to the control directives 110-a to show more or less events and associated time periods. As shown in FIG. 6, the event presentation component 124 has modified the event visualization 130 by shifting the current time period 330 to the left 5 time periods, thereby decreasing a number of days after the current time period 330 (e.g., negative time periods) by 5 days and increasing a number of days before the current time period 330 (e.g., positive time periods) by 5 days. This leaves the timeframe 324 of 17 days. However, the timeframe 324 has been shifted 5 days.

As shown in FIGS. 5, 6, the selectable GUI element 502 may be used by the user 104 to quickly manipulate the timeframe 324 to look back and ahead. This allows the user 104 to visualize a number of documents 202-c that are actually overdue and that might become overdue over multiple timeframes 324.

Shifting of the timeframe 324 by 5 days demonstrates another feature of the event timing visualization 130. The event presentation component 124 may generate the event timing visualization 130 with a custom GUI element 310-e designed to represent a cumulative time period for events having associated time periods greater than an endpoint for the second dimension 304. For instance, some or all expected events that are overdue more than the limit further back in time than shown in a given timeframe 324 can spill over in a default category referred to as a backlog slot 602. This can be shown in a stacked bar with counts similar to the other bars in the event timing visualization 130. As shown in FIG. 6, the backlog slot 602 is placed on the most left side of the x-axis to conform to the timeline, although it could be placed in other positions as well. For instance, when the user 104 shifts the timeframe 324 by 5 days, the documents 202-c previously shown and associated with time periods-13 and -10 as represented by GUI elements 310-1, 310-2 are now presented in the backlog slot 602. The backlog visualization feature can be configured on or off. Depending on a given business process that this is used for it may be that events that go into the backlog would be outdated and not relevant to follow up on since other things may have happened that makes the exception irrelevant.

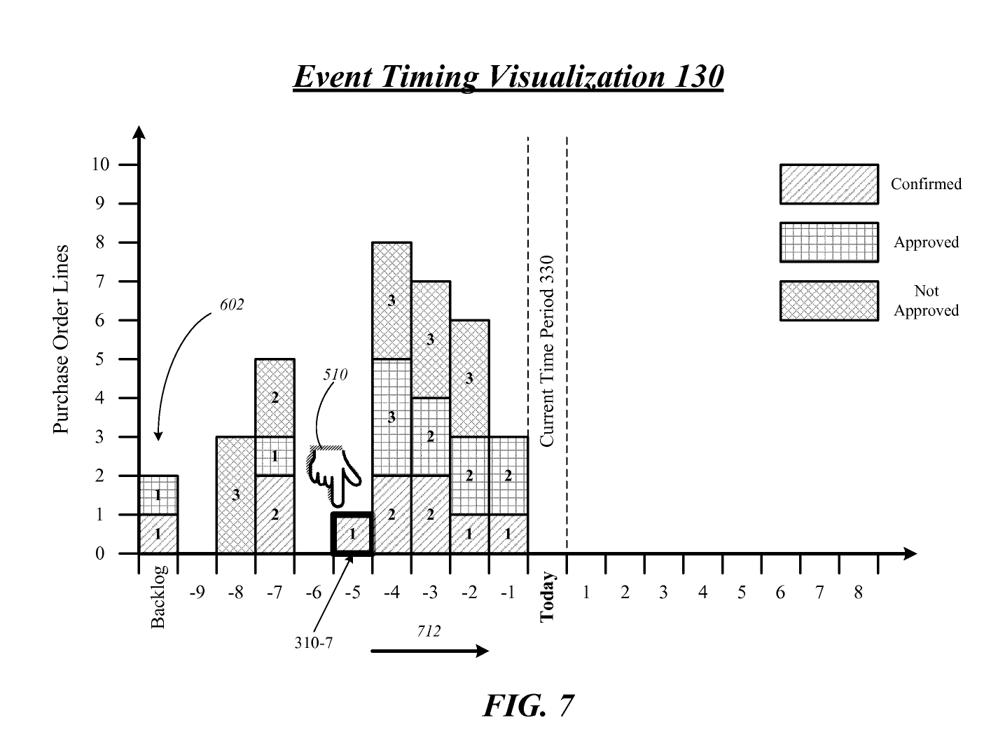

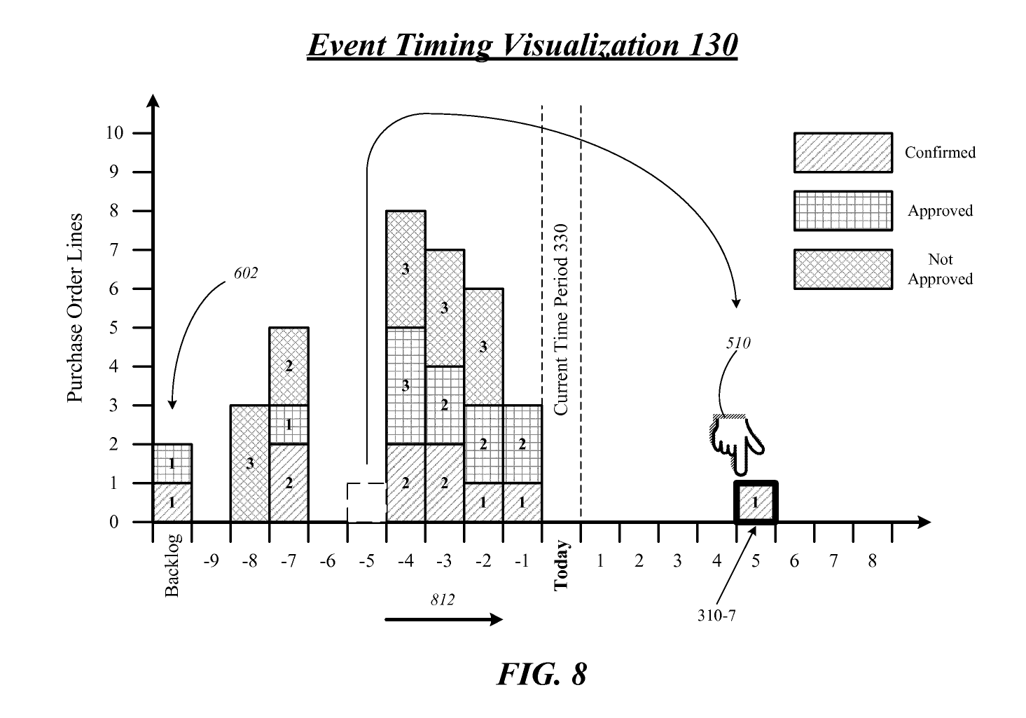

It may be appreciated that the selectable GUI element 502 is only one example of a selectable GUI element, and any number of selectable GUI elements 502 may be used as desired for a given implementation. For instance, other examples are provided with reference to FIGS. 7, 8.

FIG. 7 illustrates an exemplary implementation for the event timing visualization 130 with further description of one or more GUI elements 310-e configured as selectable GUI elements prior to activation. A GUI element 310-e may serve a dual-role in representing a count for a document 202-c and also for modifying a time period 204-d associated with the GUI element 310-e. As shown in FIG. 7, the user 104 may use a human interface device such as a touch screen to select a GUI element 310-7 to activate a time modification feature. The user interface component 122 may receive one or more control directives 110-a indicative of selection of a selectable GUI element 310-e of the event timing visualization 130 representing an event to move the selected event from a current position to a new position between the set of endpoints 320, 322 for the second dimension 304. For instance, the user interface component 122 may receive one or more control directives 110-a indicative of selection of the selectable GUI element 310-7 of the event timing visualization 130 representing an event to move the selected event from a current position at −5 days to a new position somewhere between the set of endpoints 320, 322 for the second dimension 304, as shown in FIG. 8.

FIG. 8 illustrates an exemplary implementation for the event timing visualization 130 with further description of one or more GUI elements 310-e configured as selectable GUI elements after activation. Resuming the example described in FIG. 7, assume a user moves the selected GUI element 310-7 in direction 812 from the time period of negative 5 days to positive 5 days. The user interface component 122 will receive the corresponding control directives 110-a from the human interface device, perform any processing needed on the control directives 110-a, and forward instructions to the event presentation component 124. The event presentation component 124 may move an event from a current position to a new position between the set of endpoints 320, 322 for the second dimension 304. For instance, the event presentation component 124 may move the GUI element 310-7 from a current position at −5 days to a new position of +5 days between the set of endpoints 320, 322 for the timeframe 324.

Additionally or alternatively, the event presentation component 124 may react to user interface events (e.g., resembling user interaction) by providing instructions to the user interface component 122. The instructions may relate to content, position and/or format information to present on a GUI view 128, leaving the underlying details of how to present such information to the user interface component 122.

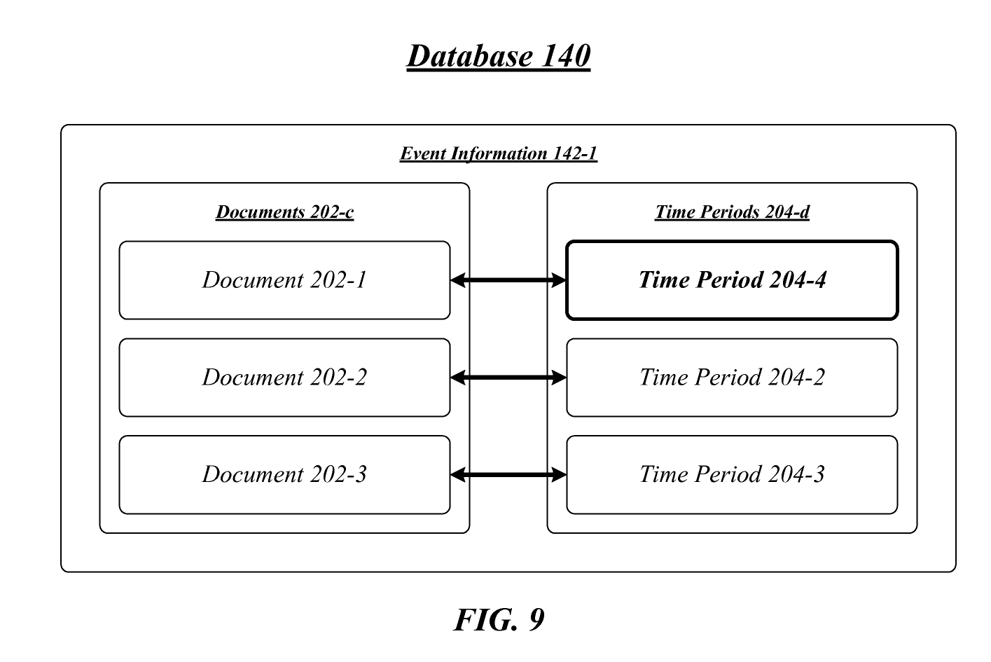

FIG. 9 illustrates an exemplary implementation of operations associated with movement of an event between positions within the timeframe 324. In addition to updating a position for an event, the event presentation component 124 may also modify an associated time period 204-d for the moved event to match a time period indicated by a new position. For instance, when the event presentation component 124 moves the GUI element 310-7 from a current position at −5 days to a new position of +5 days between the set of endpoints 320, 322 for the timeframe 324, the event presentation component 124 may instruct the event information component 126 to update the event information 142-b stored in the database 140. As shown in FIG. 9, the record for event information 142-1 may change a time period 204-d for the document 202-1 from time period 202-1 to 202-4, with the time period 202-4 comprising a date associated with the new position of +5 days of the timeframe 324.

In some cases, moving an object when the object is a business document with an expected event, or an overdue event that has not happened yet, could have deeper implications. For instance, when moving a purchase order to +5 days may actually mean that a new expected delivery date has now been set for the document, which could have other consequences. For example, there might be certain requirements for the document that are not fulfilled, such as a sales order that cannot be delivered in time. As such, moving an object may present a user with the ripple effect that would link into the supply chain processes supported by the event visualization system 100. Less complex versions of an event timing visualization 130, such as where the expected events that are visualized are more “isolated” events, can be handled in a more independent manner.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

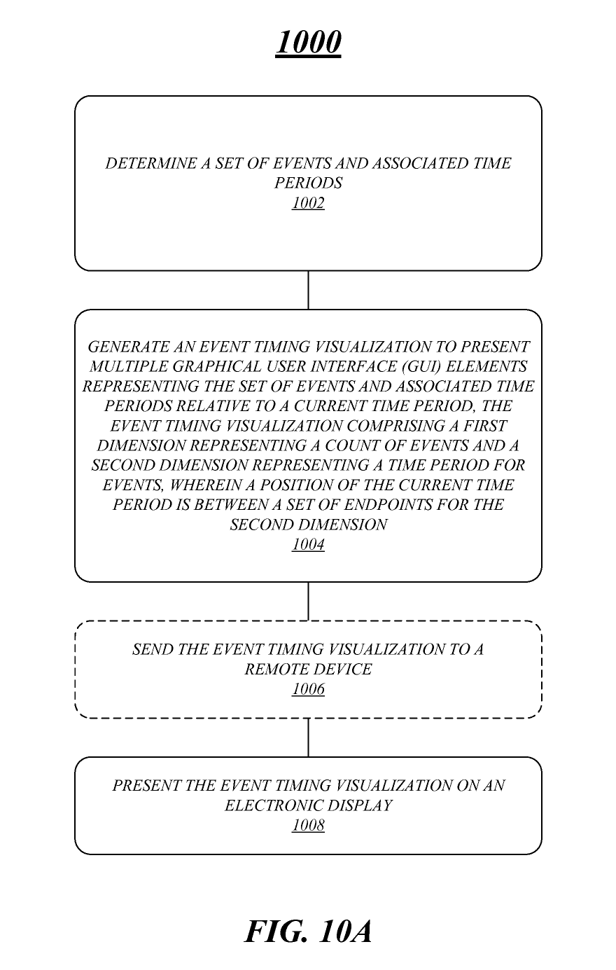

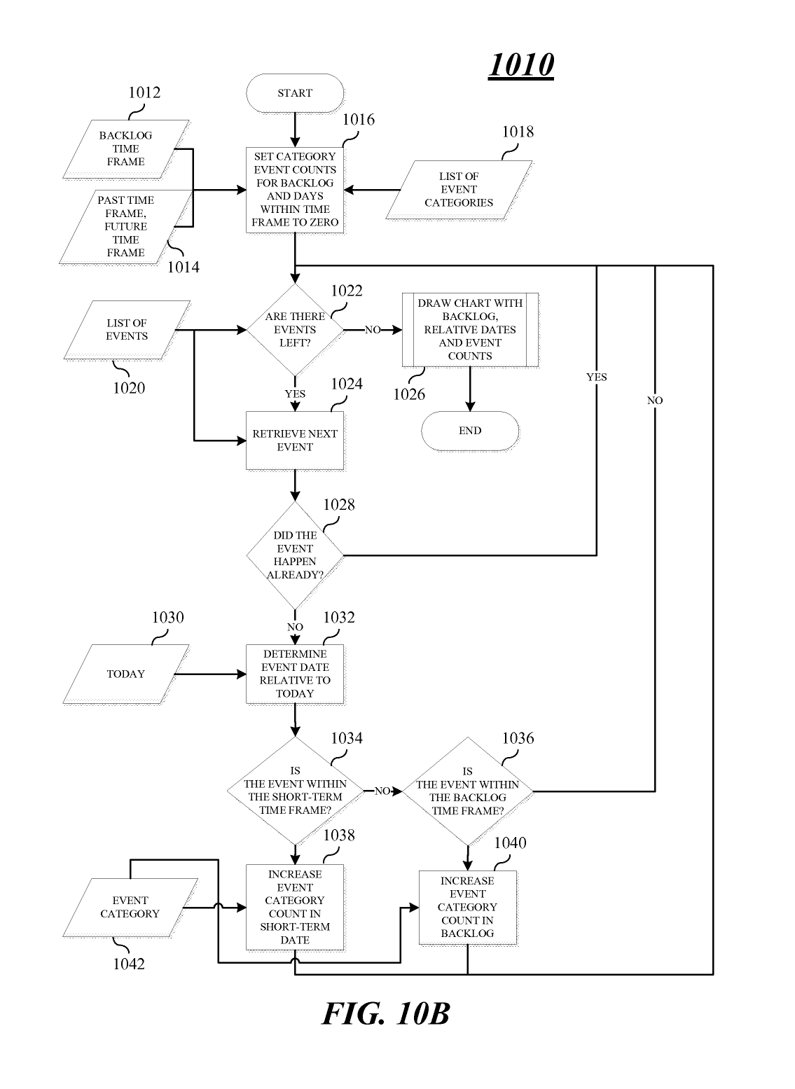

FIG. 10A illustrates one embodiment of a logic flow 1000. The logic flow 1000 may be representative of some or all of the operations executed by one or more embodiments described herein, such as the event presentation component 124, for example.

In the illustrated embodiment shown in FIG. 10, the logic flow 1000 may determine a set of events and associated time periods at block 1002. For instance, the event information component 126 may determine a set of events and associated time periods from event information 142-b stored in the database 140. The database 140 may be local database implemented in the same device as the event visualization application 120, or a remote database implemented in a different device as the event visualization application 120. An event may comprise a document 202-c or a state of a document 202-c, while an associated time period may comprise a time period 204-d associated with the document 202-c or the state of the document 202-c. An example of a document 202-1 may comprise a purchase order, and the time period 204-1 may comprise a due date for delivery of a product or service specified by the purchase order.

The logic flow 1000 may generate an event timing visualization to present multiple graphical user interface (GUI) elements representing the set of events and associated time periods relative to a current time period, the event timing visualization comprising a first dimension representing a count of events and a second dimension representing a time period for events, wherein a position of the current time period is between a set of endpoints for the second dimension, at block 1004. For instance, the event presentation component 124 may receive event information 142-b from the event information component 126, and generate an event timing visualization 130 to present multiple GUI elements 310-e representing the set of events (e.g., documents 202-c) and associated time periods (e.g., time periods 204-d) relative to a current time period 330. The event timing visualization 130 may comprise a first dimension 302 representing a count of events and a second dimension 304 representing a time period for events, wherein a position of the current time period 330 is between a set of endpoints 320, 322 for the second dimension 304. Examples for the event timing visualization 130 in various configurations are shown in FIGS. 3-8, although other configurations are possible.

The logic flow 1000 may optionally send the event timing visualization to a remote device prior to presenting the event timing visualization on the electronic display at block 1006. For instance, in those cases where the electronic display is located at a remote device, the user interface component 122 may utilize a wired or wireless transceiver to send the event timing visualization 130 to the remote device prior to presenting the event timing visualization 130 on the electronic display, as described for block 1008 below. Variations of this concept are described with reference to FIGS. 11-14.

The logic flow 1000 may present the event timing visualization on an electronic display at block 1008. For instance, once generated, the user interface component 122 may present the event timing visualization 130 on an electronic display for a device. In some cases, the electronic display may be implemented in a local device that is the same device implementing the event visualization application 120. In other cases, the electronic display may be implemented in a remote device from a device implementing the event visualization application 120.

FIG. 10B illustrates one embodiment of a logic flow 1010. The logic flow 1010 may be representative of some or all of the operations executed by one or more embodiments described herein, such as the event presentation component 124, for example. More particularly, the logic flow 1010 may be an exemplary implementation for the logic flow 1000 as described with reference to FIG. 10A.

As shown in FIG. 10B, the logic flow 1010 may perform system initialization at blocks 1012, 1014, 1016 and 1018 in preparation for generating an event timing visualization 130. The logic flow 1010 may set category event counts for backlog and days within timeframe 324 to zero at block 1016. The logic flow 1010 may determine (or retrieve) a backlog timeframe at block 1012, a timeframe 324 that includes both past time periods and future time frames relative to a current time period 330 at block 1014, and a list of event categories at block 1018.

The event presentation component 124 works with a list of counters that will be represented later on in an event timing visualization 130. For each value in the visualization x-axis, in turn there will also be a counter per category. These counters will store, for each specific date within the short-term timeframe 324 or the backlog timeframe, a number of events that fall within that particular date by category. For example, if there were 3 categories, for each day there would be stored three counters, one per category. For the backlog group, 3 counters would be initialized as well.

Afterwards, a list of events is retrieved at block 1020, which may have been optionally pre-filtered by some custom criteria. For each event in that list, any event that has already happened will be ignored, so only the events expected to happen either in the past of the future will be processed. The list of events is processed starting at diamond 1022, which determines whether any events on the list are left for processing. Note the diamond shape may represent a conditional or decision operation. If the outcome of the decision of diamond 1022 is that there are no events on the list left for processing, the logic flow 1010 will generated the event timing visualization 130 at block 1026, and the process ends.

If yes at diamond 1022, the logic flow 1010 will retrieve a next event from the list for processing at block 1024. The logic flow 1010 will determine whether the event has already occurred at diamond 1028. If yes at diamond 1028, the event is ignored, and control is passed back to diamond 1022 to process the next event on the list of events.

If no at diamond 1028, the logic flow 1010 will retrieve a current time period 330 (e.g., today) from block 1030, and determine an event date relative to a current time period 330 (e.g., today) at block 1032. The logic flow 1010 will determine whether that relative date is within the short-term timeframe 324 that will be presented in the event timing visualization 130 at diamond 1034. In other words, the short-term timeframe 324 includes a given number of days to the left and right of today.

If the event is outside of the short-term timeframe 324 as determined at diamond 1034 and also outside of the backlog timeframe as determined at diamond 1036, it will be discarded, and control is passed back to diamond 1022. However, if the event is outside of the short-term timeframe 324 at diamond 1034 but within the backlog timeframe at diamond 1026, the logic flow 1010 increases a backlog event count retrieved from block 1042 for the specific event category at block 1040, and control is passed back to diamond 1022 to process the next event. Referring again to legend 312 as shown in FIG. 3, for example, the specific event categories are not approved, approved, and confirmed.

If the event is within the short-term timeframe 324 at diamond 1034, the logic flow 1010 increases an event count for that short-term date for the specific event category retrieved from block 1042, and control is passed back to diamond 1022 to process the next event. Once the entire list of events has been processed, the logic flow 1010 will generate the event timing visualization 130 based on the different count values.

FIG. 11A illustrates a block diagram of a centralized system 1100. The centralized system 1100 may implement some or all of the structure and/or operations for the event visualization system 100 in a single computing entity, such as entirely within a single computing device 1120.

The computing device 1120 may execute processing operations or logic for the event visualization system 100 using a processing component 1130. The processing component 1130 may comprise various hardware elements, software elements, or a combination of both. Examples of hardware elements may include devices, logic devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing device 1120 may execute communications operations or logic for the event visualization system 100 using a communications component 1140. The communications component 1140 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 1140 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1124 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media 1124.

The computing device 1120 may communicate with other devices 1110, 1150 over a communications media 1124 using communications signals 1122 via the communications component 1140. For example, the computing device 1120 may receive event information 142-b from a remote datastore implemented by a server device 1110. In another example, a client device 1150 may access the event visualization system 100 to generate and interact with an event timing visualization 130 via a client application, such as a web browser or client version of the event visualization system 100, for example.

FIG. 11B illustrates a block diagram of an exemplary implementation for the centralized system 1100 as described with reference to FIG. 11A. The centralized system 1100 may implement some or all of the structure and/or operations for the event visualization system 100 in a single computing entity, such as entirely within a single computing device 1120.

The event visualization system 100 may be implemented in a single computing device 1120, such as a mobile device as previously described with reference to FIG. 11A. Some examples of mobile devices may include smart phones, handheld computers, wearable computers, tablet computers, laptop computers, palmtop computers, notebook computers, and similar devices. FIG. 11B illustrates a mobile device, such as a smart phone or a tablet computer, presenting a user interface 1160 with an event timing visualization 130 on an electronic display 1162. The smart phone or tablet computer may have a touch screen interface to allow manipulation of the event timing visualization 130. The smart phone or tablet computer may also implement other types of human interface devices, such as a microphone to accept verbal commands. The embodiments are not limited in this context.

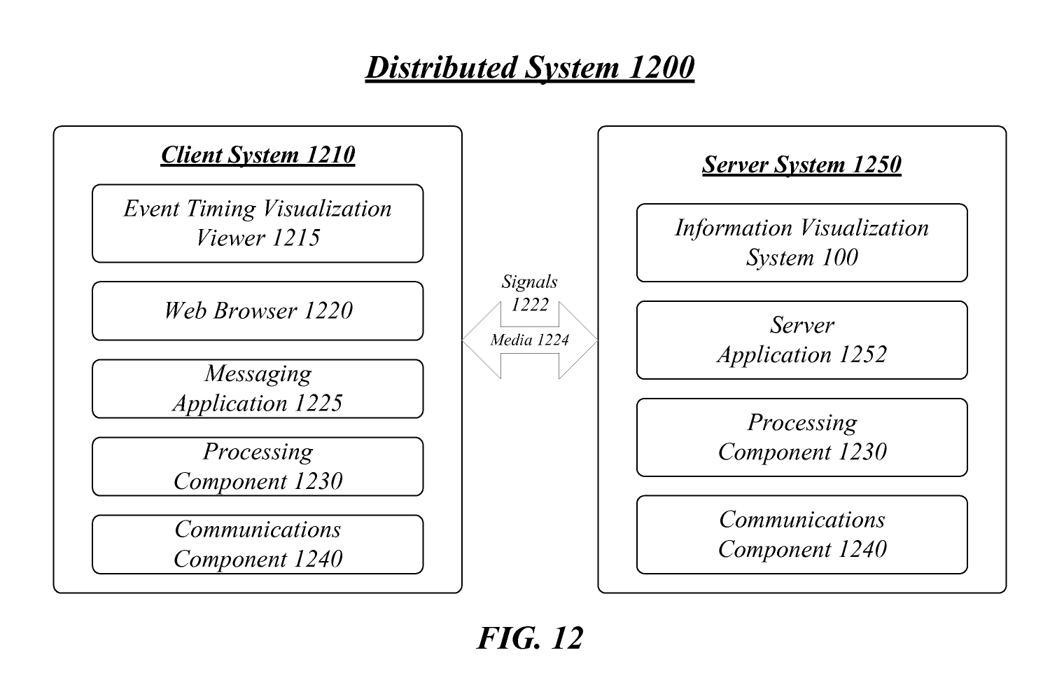

FIG. 12 illustrates a block diagram of a distributed system 1200. The distributed system 1200 may distribute portions of the structure and/or operations for the event visualization system 100 across multiple computing entities. Examples of distributed system 1200 may include without limitation a client-server architecture, a S-tier architecture, an N-tier architecture, a tightly-coupled or clustered architecture, a peer-to-peer architecture, a master-slave architecture, a shared database architecture, and other types of distributed systems. The embodiments are not limited in this context.

The client system 1210 and the server system 1250 may process information using the processing components 1230, which are similar to the processing component 1130 described with reference to FIGS. 11A, 11B. The client system 1210 and the server system 1250 may communicate with each over a communications media 1224 using communications signals 1222 via communications components 1240, which are similar to the communications component 1140 described with reference to FIG. 11A.

In one embodiment, for example, the distributed system 1200 may be implemented as a client-server system. A client system 1210 may implement an event timing visualization viewer 1215, a web browser 1220, a processing component 1230 and a communications component 1240. The client system 1210 may optionally implement some or all of the event visualization system 100. A server system 1250 may implement some or all of the event visualization system 100, one or more server applications 1252, a processing component 1230 and a communications component 1240.

In various embodiments, the client system 1210 may comprise or employ one or more client computing devices and/or client programs that operate to perform various methodologies in accordance with the described embodiments. For example, the client system 1210 may implement the web browser 1220 to access the event visualization system 100 to generate an event timing visualization 130. This may be particularly suitable for use scenarios where a set of event information 142-b is too large for processing by the client system 1210. In this case, one or more server systems 1250 may be used to process larger quantities of data for an event timing visualization 130, and the actual event timing visualization 130 may be presented via web technologies, such as the web browser 1220 and related techniques (e.g., web applications, web services, etc.). Similarly, a cloud-computing scenario may effectively utilize this configuration.

Additionally or alternatively, a stand-alone companion application to the event visualization system 100 may be implemented as a client application specifically designed to interoperate with the event visualization system 100. For example, the client system 1210 may implement an event timing visualization viewer 1215 as a thin-client application designed to send control directives 110-a as inputs to the event visualization system 100 executing on the server system 1250, and present an event timing visualization 130 as output from the event visualization system 100.

The client system 1210 may further implement a messaging application 1225 for managing incoming and outgoing messages, such as programs for providing unified messaging (UM) for e-mail, voicemail, voice over internet protocol (VoIP), instant messaging (IM), group IM, short message service (SMS), multimedia message service (MMS), enhanced presence, and audio-video conferencing, and/or other types of programs, applications, or services in accordance with the described embodiments. The client system 1210 may use the messaging application 1225 to receive an event timing visualization 130, or associated objects, GUI views, messages and so forth.

In various embodiments, the server system 1250 may comprise or employ one or more server computing devices and/or server programs that operate to perform various methodologies in accordance with the described embodiments. For example, when installed and/or deployed, a server program may support one or more server roles of the server computing device for providing certain services and features. Exemplary server systems 1250 may include, for example, stand-alone and enterprise-class server computers operating a server OS such as a MICROSOFT® OS, a UNIX® OS, a LINUX® OS, or other suitable server-based OS. Exemplary server programs may include, for example, communications server programs for managing incoming and outgoing messages, messaging server programs for providing unified messaging (UM) for e-mail, voicemail, VoIP, instant messaging (IM), group IM, SMS, MMS, enhanced presence, and audio-video conferencing, and/or other types of programs, applications, or services in accordance with the described embodiments.

In various embodiments, the server system 1250 may implement some or all of the event visualization system 100. In one embodiment, for example, the server system 1250 may implement both the event visualization application 120 and the database 140 arranged to store event information 142-b. In one embodiment, for example, the server system 1250 may implement just the event visualization application 120, while the database 140 arranged to store event information 142-b is implemented in a different server or the client system 1210. In one embodiment, the server system 1250 may implement the database 140 arranged to store event information 142-b for use by the event visualization application 120 implemented on a different server. This would be advantageous when the event information 142-b requires a larger or updated datastore relative to a local datastore implemented by the client system 1210.

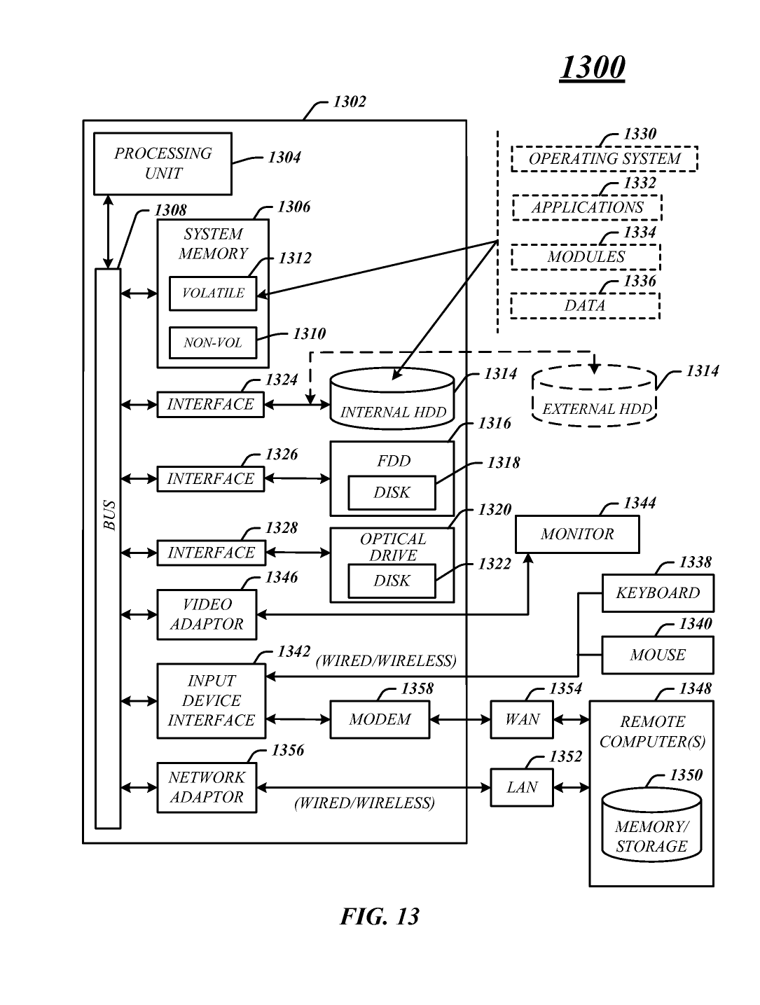

FIG. 13 illustrates an embodiment of an exemplary computing architecture 1300 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 1300. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 1300 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 1300 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1300.

As shown in FIG. 13, the computing architecture 1300 comprises a processing unit 1304, a system memory 1306 and a system bus 1308. The processing unit 1304 can be any of various commercially available processors. Dual microprocessors and other multi-processor architectures may also be employed as the processing unit 1304. The system bus 1308 provides an interface for system components including, but not limited to, the system memory 1306 to the processing unit 1304. The system bus 1308 can be any of several types of bus structure that may further interconnect to a memory bus (with or without a memory controller), a peripheral bus, and a local bus using any of a variety of commercially available bus architectures.

The computing architecture 1300 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 1306 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 13, the system memory 1306 can include non-volatile memory 1310 and/or volatile memory 1312. A basic input/output system (BIOS) can be stored in the non-volatile memory 1310.

The computer 1302 may include various types of computer-readable storage media in the form of one or more lower speed memory units, including an internal hard disk drive (HDD) 1314, a magnetic floppy disk drive (FDD) 1316 to read from or write to a removable magnetic disk 1318, and an optical disk drive 1320 to read from or write to a removable optical disk 1322 (e.g., a CD-ROM or DVD). The HDD 1314, FDD 1316 and optical disk drive 1320 can be connected to the system bus 1308 by a HDD interface 1324, an FDD interface 1326 and an optical drive interface 1328, respectively. The HDD interface 1324 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1310, 1312, including an operating system 1330, one or more application programs 1332, other program modules 1334, and program data 1336.

The one or more application programs 1332, other program modules 1334, and program data 1336 can include, for example, the event visualization application 120, the event presentation component 124, the event information component 126, the user interface component 122, the data analysis application 1252, and so forth.

A user can enter commands and information into the computer 1302 through one or more wire/wireless input devices, for example, a keyboard 1338 and a pointing device, such as a mouse 1340. Other input devices may include a microphone, an infra-red (IR) remote control, a joystick, a game pad, a stylus pen, touch screen, or the like. These and other input devices are often connected to the processing unit 1304 through an input device interface 1342 that is coupled to the system bus 1308, but can be connected by other interfaces such as a parallel port, IEEE 1394 serial port, a game port, a USB port, an IR interface, and so forth.

A monitor 1344 or other type of display device is also connected to the system bus 1308 via an interface, such as a video adaptor 1346. In addition to the monitor 1344, a computer typically includes other peripheral output devices, such as speakers, printers, and so forth.

The computer 1302 may operate in a networked environment using logical connections via wire and/or wireless communications to one or more remote computers, such as a remote computer 1348. The remote computer 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wire/wireless connectivity to a local area network (LAN) 1352 and/or larger networks, for example, a wide area network (WAN) 1354. Such LAN and WAN networking environments are commonplace in offices and companies, and facilitate enterprise-wide computer networks, such as intranets, all of which may connect to a global communications network, for example, the Internet.

When used in a LAN networking environment, the computer 1302 is connected to the LAN 1352 through a wire and/or wireless communication network interface or adaptor 1356. The adaptor 1356 can facilitate wire and/or wireless communications to the LAN 1352, which may also include a wireless access point disposed thereon for communicating with the wireless functionality of the adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wire and/or wireless device, connects to the system bus 1308 via the input device interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

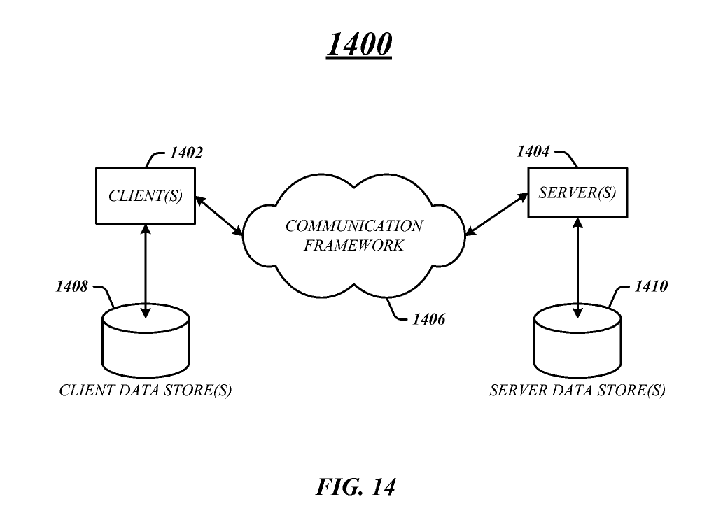

FIG. 14 illustrates a block diagram of an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, and so forth. The embodiments, however, are not limited to implementation by the communications architecture 1400.

As shown in FIG. 14, the communications architecture 1400 comprises includes one or more clients 1402 and servers 1404. The clients 1402 may implement the device 1110, the device 1150, the computing device 1120, or the client system 1210. The servers 1404 may implement the device 1110, the device 1150, the computing device 1120, or the server system 1250. The clients 1402 and the servers 1404 are operatively connected to one or more respective client data stores 1408 and server data stores 1410 that can be employed to store information local to the respective clients 1402 and servers 1404, such as cookies and/or associated contextual information.

The clients 1402 and the servers 1404 may communicate information between each other using a communication framework 1406. The communications framework 1406 may implement any well-known communications techniques and protocols, such as those described with reference to the event visualization system 100. The communications framework 1406 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor circuit; and
an event visualization application operative on the processor circuit, the event visualization application comprising an event information component operative to determine a set of events and associated time periods, and an event presentation component operative to generate an event timing visualization to present multiple graphical user interface (GUI) elements representing the set of events and associated time periods relative to a current time period, the event timing visualization comprising a first dimension representing a count of events and a second dimension representing a time period for events, wherein a position of the current time period is between a set of endpoints for the second dimension.

2. The apparatus of claim 1, the event timing visualization comprising a bar graph.

3. The apparatus of claim 1, the first dimension comprising a y-axis of a graph.

4. The apparatus of claim 1, the second dimension comprising an x-axis of a graph.

5. The apparatus of claim 1, the event presentation component operative to generate the event timing visualization with a GUI element to represent a cumulative time period for events having associated time periods greater than an endpoint for the second dimension.

6. The apparatus of claim 1, the event visualization application comprising a user interface component operative to receive a control directive indicative of selection of a selectable GUI element of the event timing visualization representing the current time period to move the position of the current time period between the set of endpoints for the second dimension, and move the position of the current time period within the second dimension in response to the control directive to show more or less events and associated time periods.

7. The apparatus of claim 1, the event visualization application comprising a user interface component operative to receive a control directive indicative of selection of a selectable GUI element of the event timing visualization representing an event to move the selected event from a current position to a new position between the set of endpoints for the second dimension, move the event from a current position to a new position between the set of endpoints for the second dimension, and modify an associated time period for the moved event to match a time period indicated by the new position.

8. A computer-implemented method, comprising:
determining a set of events and associated time periods; and
generating an event timing visualization to present multiple graphical user interface (GUI) elements representing the set of events and associated time periods relative to a current time period, the event timing visualization comprising a first dimension representing a count of events and a second dimension representing a time period for events, wherein a position of the current time period is between a set of endpoints for the second dimension.

9. The computer-implemented method of claim 8, comprising receiving a control directive indicative of selection of a selectable GUI element of the event timing visualization representing the current time period to move the position of the current time period between the set of endpoints for the second dimension.

10. The computer-implemented method of claim 8, comprising moving the position of the current time period within the second dimension in response to a control directive to show more or less events and associated time periods.

11. The computer-implemented method of claim 8, comprising generating the event timing visualization with a GUI element to represent a cumulative time period for events having associated time periods greater than an endpoint for the second dimension.

12. The computer-implemented method of claim 8, comprising receiving a control directive indicative of selection of a selectable GUI element of the event timing visualization representing an event to move the selected event from a current position to a new position between the set of endpoints for the second dimension.

13. The computer-implemented method of claim 8, comprising:
moving an event from a current position to a new position between the set of endpoints for the second dimension; and
modifying an associated time period for the moved event to match a time period indicated by the new position.

14. The computer-implemented method of claim 8, comprising sending the event timing visualization to a remote device.

15. The computer-implemented method of claim 8, comprising presenting the event timing visualization on an electronic display.

16. An article of manufacture comprising a computer-readable storage medium containing instructions that when executed cause a system to:
determine a set of events and associated time periods;
generate an event timing visualization to present multiple graphical user interface (GUI) elements representing the set of events and associated time periods relative to a current time period, the event timing visualization comprising a first dimension representing a count of events and a second dimension representing a time period for events, wherein a position of the current time period is between a set of endpoints for the second dimension; and
causing presentation of the event timing visualization on an electronic display.

17. The article of manufacture of claim 16, comprising instructions that when executed enable the system to generate the event timing visualization with a GUI element to represent a cumulative time period for events having associated time periods greater than an endpoint for the second dimension.

18. The article of manufacture of claim 16, comprising instructions that when executed enable the system to receive a control directive indicative of selection of a selectable GUI element of the event timing visualization representing the current time period to move the position of the current time period between the set of endpoints for the second dimension, and move the position of the current time period within the second dimension in response to a control directive to show more or less events and associated time periods.

19. The article of manufacture of claim 16, comprising instructions that when executed enable the system to receive a control directive indicative of selection of a selectable GUI element of the event timing visualization representing an event to move the selected event from a current position to a new position between the set of endpoints for the second dimension, move the event from a current position to a new position between the set of endpoints for the second dimension, and modify an associated time period for the moved event to match a time period indicated by the new position.

20. The article of manufacture of claim 16, comprising instructions that when executed enable the system to cause the event timing visualization to be sent to a remote device.
